(19) United States
(12) Patent Application Publication
(10) Pub. No.: US 2005/0033665 A1
(43) Pub. Date: Feb. 10, 2005

(54) Method, apparatus, and program for detecting item mismatch at the point of sale

(75) Inventor: David Bruce Kumhyr, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/636,982

(22) Filed: Aug. 7, 2003

(51) Int. Cl. G06F 17/60

(52) U.S. Cl. 705/28

(57) ABSTRACT

A mechanism is provided for detecting mismatched items purchased together. A data structure includes product information including mismatch information for each product. Mismatch information may be stored as a mismatch list. When-products are selected for purchase, the products are compared to determine whether any one product is identified as a mismatch for any other selected item. If a mismatch is detected, a notification is generated. The data structure may also include match information for each product. Match information may be stored as a match list. If a mismatch is detected, a corresponding item in the match list may be suggested to the purchaser. Location or direction information may also be presented to the purchaser to locate the matching item.

### BACKGROUND OF THE INVENTION

1. Technical Field

The present invention relates to data processing systems and, in particular, to point of sale systems. Still more particularly, the present invention provides a method, apparatus, and program for catching product mismatches at the point of sale.

2. Description of Related Art

Often, in a retail environment, consumers make purchases of “matched” items. For example, a consumer may purchase pillowcases, sheets, and fitted sheets, which are separate but matched items. These items may have confusing packages. For instance, every pillowcase package may have the same picture with the color indicated in small text. As another example, a consumer may purchase ceramic tile, tile mastic, and grout. These products may be shelved such that tile mastic adhesive is placed in close proximity to vinyl adhesive. As yet another example, consumers frequently buy electronic devices with batteries for operation.

In each of these examples, items that are ordinarily matched in color, size, compatibility, etc. may easily be mismatched. With the advent of self service stores and the use of fewer personnel to service large retail or wholesale stores, it has become more likely that mismatched items are purchased together.

Many times, mismatched items may not be discovered until the consumer arrives at home and has more time to inspect the packages. This results in an extra trip to the retail establishment, having to wait in a return line, locating the correct item, and waiting in line to purchase the item that should have been purchased the first time. This is an inconvenience that could have been avoided.

Furthermore, there are many times that a mismatched item is only discovered after the packages have been opened. In this case, the store's return policy may prohibit the return of opened items or the consumer may be charged a restocking fee. This may also be an inconvenience to the retail store, because the product must be returned to the manufacturer or sold at a lower price as an opened item. The store may also have to include a product protection plan at no cost to help sell an opened item.

Therefore, it would be advantageous to provide an improved method, apparatus, and program for detecting item mismatch at the point of sale.

### SUMMARY OF THE INVENTION

The present invention provides a mechanism for detecting mismatched items purchased together. A data structure includes product information. Mismatch information may be stored as a mismatch list. When products are selected for purchase, the products are compared to determine whether any one product is identified as a mismatch for any other selected item. If a mismatch is detected, a notification is generated.

The data structure may also include match information for each product. Match information may be stored as a match list. If a mismatch is detected, a corresponding item in the match list may be suggested to the purchaser. Location or direction information may also be presented to the purchaser to locate the matching item.

In an alternative embodiment, mismatching products may also be identified by comparing product information. The mechanism of the present invention may determine for each item whether other selected items are within a sphere of influence based upon the product information. If items are identified within this sphere of influence, a determination is made as to whether the items are matching items or mismatching items.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a retail data processing system in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram illustrating the hardware configuration of a personal shopping device in accordance with a preferred embodiment of the present invention;

FIG. 5 is a block diagram illustrating the hardware configuration of a point-of-sale device in accordance with a preferred embodiment of the present invention;

FIG. 6 is a block diagram illustrating an electronic price tag in accordance with a preferred embodiment of the present invention;

FIGS. 7A and 7B depict example product data structures in accordance with a preferred embodiment of the present invention;

FIGS. 8A-8C illustrate example screens of display at a point-of-sale device or a personal shopping device in accordance with a preferred embodiment of the present invention;

FIG. 9 illustrates an example printed presentation of location information in accordance with a preferred embodiment of the present invention;

FIGS. 10A and 10B are example screens of display illustrating mismatch notification in an online retail environment in accordance with a preferred embodiment of the present invention; and

FIG. 11 is a flowchart illustrating the operation of an item mismatch detection process in accordance with a preferred embodiment of the present invention.

### DETAILED DESCRIPTION OF THE PREFERRED EMBODIMENT

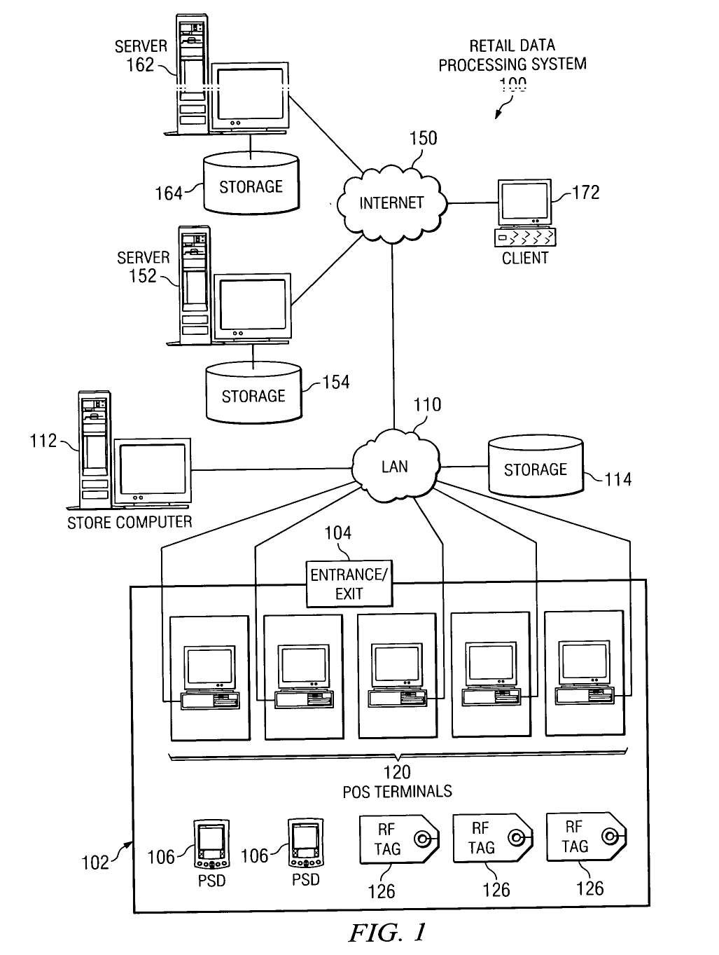

With reference now to the figures, FIG. 1 depicts a pictorial representation of a retail data processing system in which the present invention may be implemented. A shopper enters store 102 through entrance/exit 104. The shopper may collect items for purchase and bring these items to point-of-sale (POS) terminals 120. The POS terminals may have stored therein product information. Alternatively, POS terminals 120 may communicate with store computer 112 through local area network (LAN) 110. Store computer 112 may be a server computer, which provides access to storage 114.

The LAN is the medium used to provide communications links between various devices and computers connected together within retail data processing system 100. LAN 110 may include connections, such as wire, wireless communication links, or fiber optic cables. The POS terminals may access item information based on, for example, universal product code (UPC) information or stock keeping unit (SKU) information for the items. The item information may include item description, price, and the like.

In accordance with a preferred embodiment of the present invention, when a customer at one of POS terminals 120 presents items for purchase, identification information for the items is entered into the POS terminal. The identification information may include a SKU, UPC, or other product identifier, and may be scanned using a bar code reader or the like.

The POS terminal may then retrieve a product data structure for the products from local storage, store computer 112, or storage 114. The product data structure may include a mismatch data structure and a match data structure for one or more of the products being purchased. The mismatch data structure and the match data structure may be lists or tables.

In an alternative embodiment, mismatching products may also be identified by comparing product information. The mechanism of the present invention may determine for each item whether other selected items are within a sphere of influence based upon the product information. If items are identified within this sphere of influence, a determination is made as to whether the items are matching items or mismatching items. Products outside this sphere of influence are assumed to be unrelated products. However, if two or more products are related, they are either matching items or mismatched items.

The POS terminal may then determine if any one of the products is a mismatch with any other of the products based on product data. For example, if a customer purchases a box of Phillips-head screws and a Keystone-tip screwdriver, the box of Phillips-head screws may appear in the mismatch data structure for the Keystone-tip screwdriver and vice versa. Therefore, in the retail data processing system of the present invention, the POS terminal will alert the sales representative and/or the customer of the mismatch. The POS terminal may also indicate a mismatch type and a corresponding matching item from a match data structure.

Alternatively, radio frequency (RF) price tags 126 may be affixed to products. These price tags may include a passive RF transceiver that activates a controller responsive to receiving and decoding a signal. RF price tags 126 may then transmit data stored in a memory back to the requesting device, such as POS terminal 120. The data stored in RF tags 126 may include a product identifier or other data, such as a product data structure, mismatch data structure, and/or match data structure. In this case, a mismatch data structure or match data structure may consist of a list of matching or mismatching product identifiers.

In accordance with a preferred embodiment of the present invention, LAN 110 may be connected to Internet 150. In the depicted example, servers 152, 162 are connected to Internet 150 providing access to storage units 154, 164, respectively. Manufacturers may provide product information using servers 152, 162. This product information, which may include match data structures or mismatch data structures, may be downloaded to store computer 112 or storage 114 or may be accessed directly from storage 154, 164 through servers 152, 162.

In addition, client 172 also is connected to Internet 150. Client 172 may be, for example, a personal computer or network computer. In the depicted example, servers 152, 162 provide data, such as product information, to client 172. Client 172 is a client to servers 152, 162. For example, server 152 may be a world wide web server and client 172 may communicate with the web server using a browser application, as is known in the art. In a preferred embodiment of the present invention, a customer may purchase products from online retailers at servers 152, 162 through a browser application. Storage 154, 164 may include product data structures, including mismatch data structures and match data structures, to detect mismatches at the point of online sale.

Retail data processing system 100 may also include personal shopping devices 106 for assisting customers in the retail environment. A personal shopping device (PSD) may include a display and a bar code reader (not shown) for selecting items, displaying an itemized list, or for keeping a running total. Each PSD may download product data structures from store computer 112, storage 114, or from servers 152, 162. Alternatively, a PSD may communicate with devices in the retail data processing system through, for example, a wireless communications medium. Thus, the personal shopping devices may access the store computer or other storage directly, rather than storing all product information locally at the PSD.

Therefore, the PSDs may detect mismatches at the time of product selection, rather than at the point of sale. Customers may then alter product selection without inconveniencing other customers in the checkout line. A customer also may detect a mismatched item within the vicinity of a matching item. Therefore, the customer will not have to retrace steps and navigate a large retail environment to find the appropriate item.

Retail data processing system 100 may include additional servers, clients, and other devices not shown. In the depicted example, Internet 150 represents a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, retail data processing system 100 also may be implemented as a number of different types of networks, such as, for example, an intranet, a local area network (LAN), or a wide area network (WAN). Furthermore, store computer 112, storage 114, servers 152, 162, storage 114, and client 172 may all be connected to the same network, such as the Internet. Point of sale terminals 120 may be connected in a known manner to store computer 112. FIG. 1 is intended as an example, and not as an architectural limitation for the present invention.

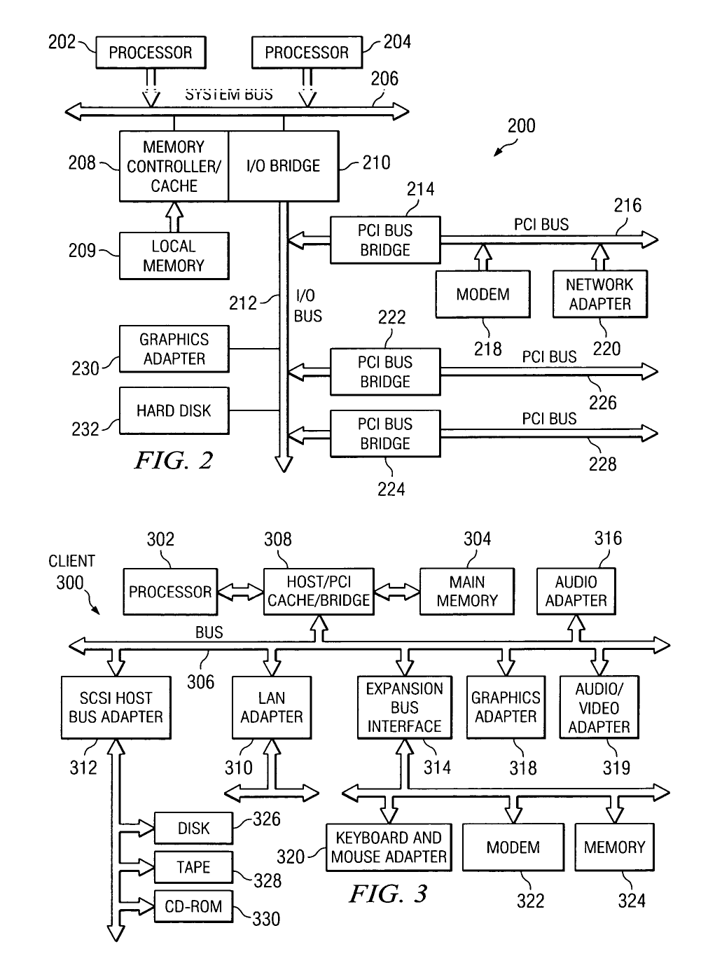

Referring to FIG. 2, a block diagram of a data processing system that may be implemented as a server, such as server 152, server 162, or store computer 112 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to client 172 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA or telephone device. Data processing system 300 also may be a kiosk or a Web appliance.

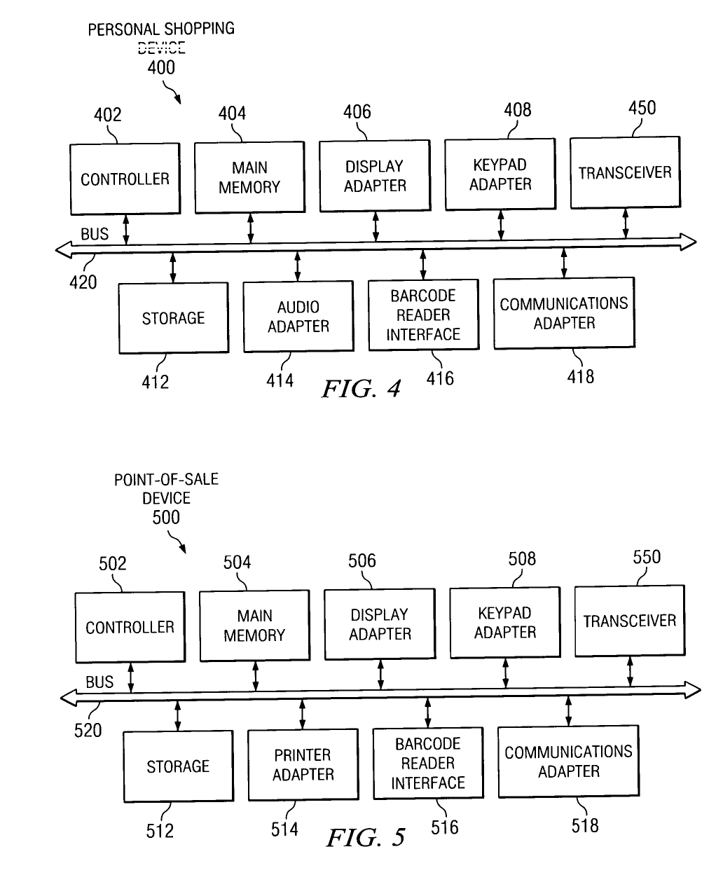

With reference now to FIG. 4, a block diagram illustrating the hardware configuration of a personal shopping device is shown in accordance with a preferred embodiment of the present invention. Personal shopping device 400 is an example of a personal shopping device in which code or instructions implementing the processes of the present invention may be located. Personal shopping device 400 employs a bus architecture. Controller 402 and main memory 404 are connected to bus 420. Display adapter 406, keypad adapter 408, storage 412, audio adapter 414, barcode reader interface 416, and communications adapter 418 are also connected to bus 420.

An operating system runs on controller 402 and is used to coordinate and provide control of various components within personal shopping device 400 in FIG. 4. The operating system may be a commercially available operating system such as Windows CE™, which is available from Microsoft Corporation, or Palm OS™ from Palm, Inc. Instructions for the operating system and applications or programs are located on storage devices, such as storage 412, and may be loaded into main memory 404 for execution by controller 402.

Barcode reader interface 416 may receive information, such as product selection information, from a barcode reader. In another embodiment of the present invention, transceiver 450, connected to bus 420, may receive information, such as a product identifier, from a radio frequency (RF) price tag. However, RF price tags may store other information, such as a product data structure, mismatch data structure, and/or match data structure.

Controller 402, under control of software, may detect mismatching items based on product data structures. Mismatch rules for determining mismatching and matching products based upon product information may be stored in storage 412. The controller may access or download the product data structures through communications link 418. Alternatively, the product data structures may be stored locally in storage 412. If a mismatch occurs, controller 402 may generate a notification for the user through audio adapter 414 and/or display adapter 406. The personal shopping device may also present a suggestion for a corresponding matching item based on the product data structures.

In addition, the suggestion for a corresponding matching item may include location or direction information for the matching item. Controller 402 may present this location or direction information through display adapter 406 or audio adapter 414. The customer may then use this information to locate the appropriate matching item.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to or in place of the hardware depicted in FIG. 4. For example, personal shopping device 400 may be a personal digital assistant (PDA), which is configured with ROM and/or flash ROM to provide non-volatile memory for storing operating system files and/or user-generated data.

The depicted example in FIG. 4 and above-described examples are not meant to imply architectural limitations. For example, personal shopping device 400 also may be a notebook computer or hand held computer in addition to taking the form of a PDA.

Turning now to FIG. 5, a block diagram illustrating the hardware configuration of a point-of-sale device is shown in accordance with a preferred embodiment of the present invention. Point-of-sale device 500 is an example of a point-of-sale device in which code or instructions implementing the processes of the present invention may be located. Point-of-sale device 500 employs a bus architecture. Controller 502 and main memory 504 are connected to bus 520. Display adapter 506, keypad adapter 508, storage 512, printer adapter 514, barcode reader interface 516, and communications adapter 518 are also connected to bus 520.

An operating system runs on processor 502 and is used to coordinate and provide control of various components within point-of-sale device 500 in FIG. 5. The operating system may be a commercially available operating system; however, the point-of-sale device may alternatively include specialized code for the point-of-sale device. Instructions for the operating system and applications or programs are located on storage devices, such as storage 512, and may be loaded into main memory 504 for execution by processor 502.

Barcode reader interface 516 may receive information, such as product selection information, from a barcode reader. In another embodiment of the present invention, transceiver 550, connected to bus 520, may receive information, such as a product identifier, from a radio frequency (RF) price tag. However, RF price tags may store other information, such as a product data structure, mismatch data structure, and/or match data structure.

Controller 502, under control of software, may detect mismatching items based on product data structures. Mismatch rules for determining mismatching and matching products based upon product information may be stored in storage 512. The controller may access or download the product data structures through communications link 518. Alternatively, the product data structures may be stored locally in storage 512. If a mismatch occurs, controller 502 may generate a notification for the sales representative or customer through display adapter 506. The point-of-sale device may also present a suggestion for a corresponding matching item based on the product data structures.

In addition, the suggestion for a corresponding matching item may include location or direction information for the matching item. Controller 502 may present this location or direction information through display adapter 506 or printer adapter 514. The customer may then use this information to locate the appropriate matching item.

Those of ordinary skill in the art will appreciate that the hardware in FIG. 5 may vary depending on the implementation. Other internal hardware or peripheral devices, such as flash ROM (or equivalent nonvolatile memory) or optical disk drives and the like, may be used in addition to or in place of the hardware depicted in FIG. 5. For example, point-of-sale device 500 may be a hand held computing device, which is configured with ROM and/or flash ROM to provide non-volatile memory for storing operating system files and/or user-generated data.

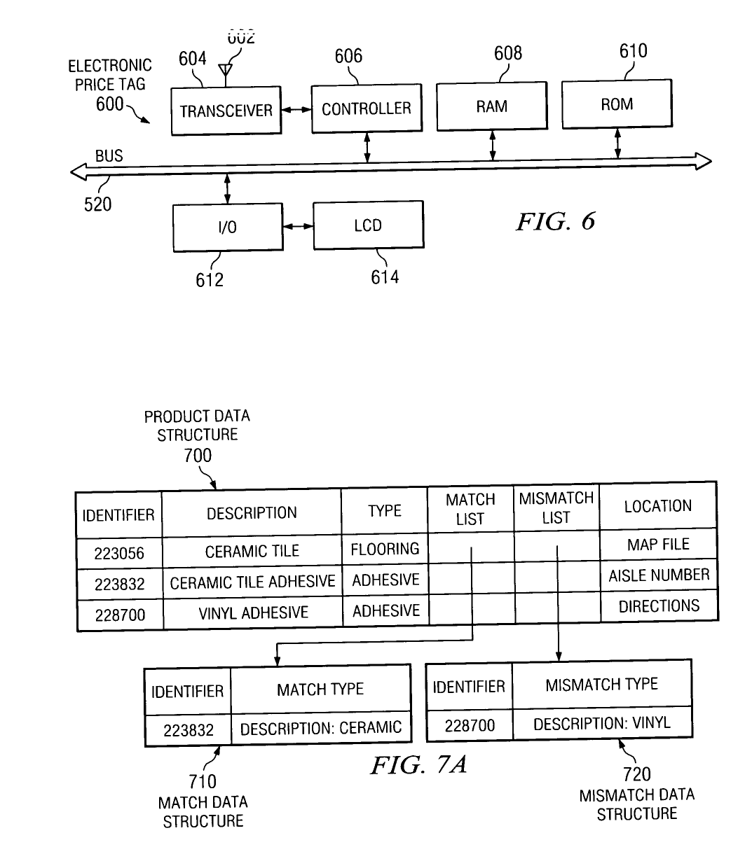

FIG. 6 is a block diagram illustrating an electronic price tag in accordance with a preferred embodiment of the present invention. Electronic price tag 600 employs a bus architecture. Controller 606, random access memory (RAM) 608, and read only memory (ROM) 610 are connected to bus 620. Controller 606 communicates with transceiver 604, which receives radio frequency signals from antenna 602. Transceiver 604 may be a passive receiver, which receives and decodes signals received from antenna 602 and activates controller 606 when an appropriate signal is received. For example, electronic price tags may have unique addresses and transceiver 604 may interrupt the controller when the address of electronic price tag 600 is received.

As an example, electronic price tag 600 may be swiped across or near a radio frequency transmitter that sends a price display command to the electronic price tag. Responsive to the signal being detected, the transceiver activates controller 606 and passes the command to the controller. In turn, controller 606 retrieves price information from storage, such as ROM 610, and displays the price on liquid crystal display (LCD) 614 via input/output (I/O) interface 612.

In accordance with a preferred embodiment of the present invention, non-volatile storage in the electronic price tag, such as ROM 610, stores product information. For example, ROM 610 may store a product identifier, price, description, and a product type. The product information may also include a mismatch list and/or a match list for the product. The mismatch list may consist of an array of product identifiers that are mismatching products. Similarly, a match list may consist of an array of product identifiers corresponding to matching products.

When an electronic price tag is programmed with product information, it may be more practical to include only a match list. A manufacturer may be motivated to suggest a set of matching items, because this may result in more sales of the matching items. For example, a manufacturer of cellular telephones may wish to include a set or list of matching accessories.

In a preferred embodiment of the present invention, mismatching products may be identified by comparing product information. The mechanism of the present invention may determine for each item whether other selected items are within a sphere of influence based upon the product information. If items are identified within this sphere of influence, a determination is made as to whether the items are matching items or mismatching items. The mechanism of the present invention may include a set of rules to determine whether an item is a matching item or a mismatched item based upon product information.

As an example, considering the cellular telephone example, if a customer selects a cellular telephone and a hands-free adapter for purchase, the mechanism of the present invention may determine whether the hands-free adapter belongs to the list of matching items. If the hands-free adapter does not belong to the recommended list of matching items, then the product information of the selected hands-free adapter may be compared to the product information of the recommended hands-free adapter to determine whether the selected product is a matching item or a mismatching item. The product information may include information, such as “BlueTooth,” “miniplug,” or a brand name. This information may be used to determine whether the item is a matching item or a mismatched item.

Responsive to activation, controller 606 may send product information from internal storage to the requesting device. Thus, a personal shopping device or point of sale terminal may query each electronic price tag in a shopping cart or basket. Based on the transmitted product information, the device may identify potential product mismatches. Since the electronic price tags transmit for short distances, they can be queried in a pre-checkout scan, allowing the shopper to be alerted of product mismatches or incompatibilities prior to reaching the front of the checkout line.

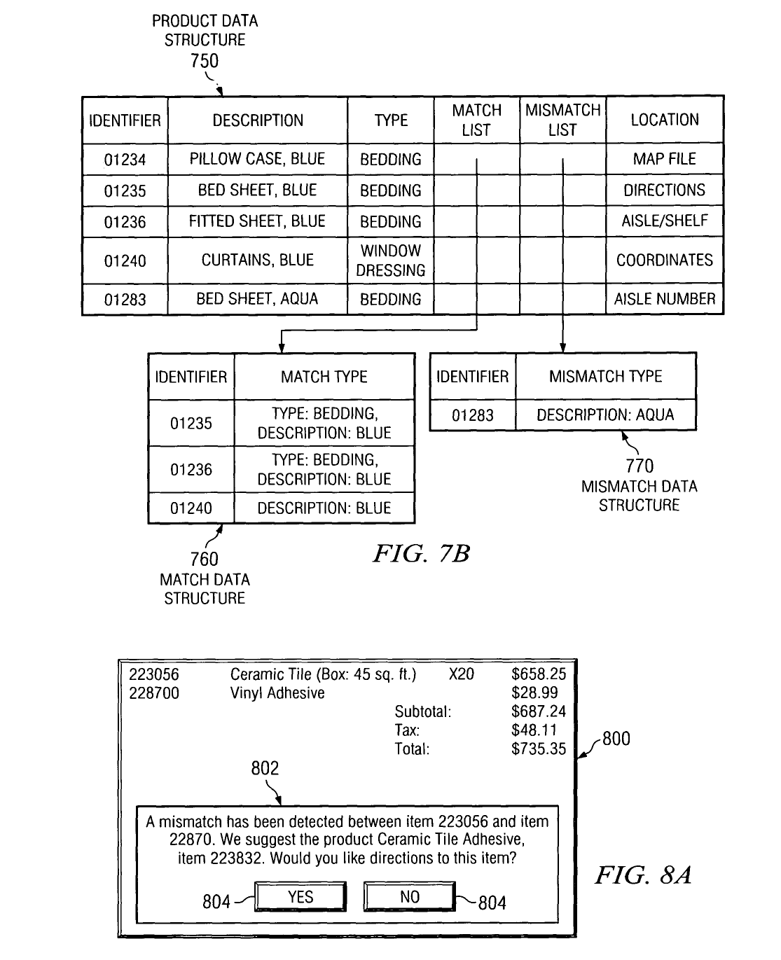

FIGS. 7A and 7B depict example product data structures in accordance with a preferred embodiment of the present invention. More particularly, with reference to FIG. 7A, product data structure 700 includes entries or records for individual products. Each entry or record includes a product identifier, a product description, a product type, a reference to a match list, a reference to a mismatch list, and location information for the product. The product identifier may be a SKU or UPC identifier, for example. Preferably, the product description and product type include sufficient information to identify the product and to identify matching products. For example, if a mismatched item is of type “adhesive,” then a suggested matched item may be determined by identifying a matching item in the match data structure of type “adhesive.”

As a specific example, product identifier “223056” refers to a ceramic tile, as indicated by its product description. The product type for the ceramic tile product is “flooring.” The product data structure also includes a reference to match data structure 710 and mismatch data structure 720. In this example, the mismatch data structure includes one entry for product identifier “228700.” This product identifier refers to a vinyl adhesive, which also has an entry in product data structure 700. The mismatch entry also includes a mismatch type of “Description:Vinyl.” Also shown in this example, match data structure 710 includes one entry for product identifier “223832.” This product identifier refers to a ceramic tile adhesive, which has an entry in product data structure 700 as well.

In accordance with a preferred embodiment of the present invention, if a customer selects item “223056” and item “228700,” then a mismatch will be detected. The sales representative or the customer will be notified of the mismatch. In this example, item “223832” will be suggested as a corresponding matching product, because the item appears in the match data structure and has the same product type. Location information may also be presented. In the depicted example, location information may include a reference to a map file, directions information, or an aisle number. The location information for item “223832” consists of an aisle number.

Alternatively, the persistently stored product information may not include a mismatch list or match list. In fact, when product information is provided, it may be practical to include only a match list, such as match data structure 710. A manufacturer may be motivated to suggest a set of matching items, because this may result in more sales of the matching items. For example, a manufacturer of ceramic tile may wish to include a set or list of ceramic tile adhesives of the same brand.

In a preferred embodiment of the present invention, mismatching products may be identified by comparing product information. The mechanism of the present invention may include a set of rules to determine for each item whether other selected items are within a sphere of influence based upon the product information. If items are identified within this sphere of influence, a determination is made as to whether the items are matching items or mismatching items.

As an example, considering the ceramic tile example, if a customer selects a ceramic tile (product 223056) and vinyl adhesive (product 228700) for purchase, the mechanism of the present invention may determine whether the adhesive belongs to a list of matching items. In this case, the vinyl adhesive does not belong to the recommended list of matching items; therefore, the product information of the selected vinyl adhesive may be compared to the product information of the recommended ceramic tile adhesive to determine whether the selected product is a matching item or a mismatching item. The product information may include information, such as a product description and product type. This information may be used to determine whether the item is a matching item or a mismatched item.

If the selected item matches the recommended matching product in product type and description, for example, the mechanism of the present invention may determine that the selected item is a matching item using the set of rules. On the other hand, the item may be within the sphere of influence of the ceramic tile item because it also is an adhesive for a flooring product. However, the selected item may have a non-matching material in the description. Thus, the mechanism of the present invention may determine that the selected item is a mismatched item even though the item is within the sphere of influence of the ceramic tile item. The set of rules must anticipate the types of mismatch that may happen, such as material incompatibility, differences in product makes and models, color incompatibility, size mismatch, and the like.

With reference now to FIG. 7B, product data structure 750 includes entries or records for individual products. Each entry or record includes a product identifier, a product description, a product type, a reference to a match list, a reference to a mismatch list, and location information for the product. The product identifier may be a SKU or UPC identifier, for example. Preferably, the product description and product type include sufficient information to identify the product and to identify matching products. For example, if a mismatched item is of type “bedding” and includes the term “bed sheet” in the description, then a suggested matched item may be determined by identifying a matching item in the match data structure of type “adhesive” and having the term “bed sheet” in the description.

As a specific example, product identifier “01234” refers to a blue pillow case, as indicated by its product description. The product type for the pillow case product is “bedding.” The product data structure also includes a reference to match data structure 760 and mismatch data structure 770. In this example, the mismatch data structure includes one entry for product identifier “01283.” This product identifier refers to an aqua colored bed sheet, which also has an entry in product data structure 750. The mismatch entry also includes a mismatch type of “Description:Aqua.”

Also shown in this example, match data structure 760 includes entries for product identifiers “01235,” “01236,” and “01240.” Product identifier “01235” refers to a blue bed sheet; product identifier “01236” refers to a blue fitted bed sheet; and, product identifier “01240” refers to an aqua colored bed sheet. These products also have entries in product data structure 750. In accordance with a preferred embodiment of the present invention, if a customer selects item “01234” and item “01283,” then a mismatch will be detected. The sales representative or the customer will be notified of the mismatch.

In this example, item “01236” matches product “01234” in type; however, the mismatched item is a bed sheet and item “01236” is a fitted bed sheet. Item “01240” matches item “01235” in color, but is not of the same product type as the mismatched item. Item “01235” will be suggested as a corresponding matching product, because the item appears in the match data structure and has the same product type and matches item “01234” in color.

Location information may also be presented for the matching item. In the depicted example, location information may include a reference to a map file, directions information, an aisle number, an aisle and shelf number, or coordinates, which may be used to locate the item on a map or using a navigation device. The location information for item “01235” consists of directions, which may be presented on a display or audio output device. Location information may also be printed using, for example, a receipt printer or the like.

As described above, mismatching products may also be identified by comparing product information. The mechanism of the present invention may determine for each item whether other selected items are within a sphere of influence based upon the product information. If items are identified within this sphere of influence, a determination is made as to whether the items are matching items or mismatching items.

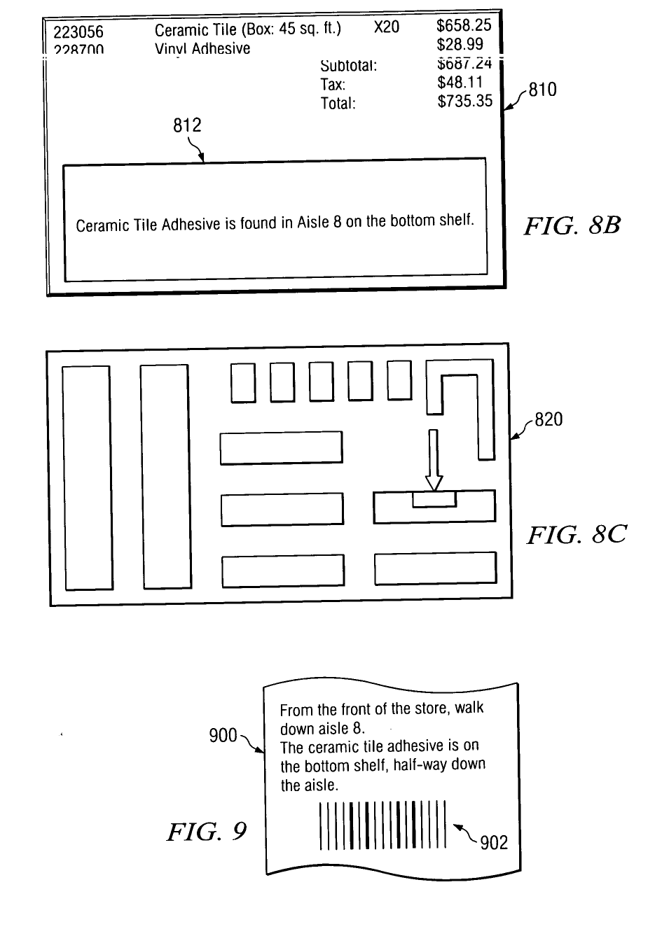

FIGS. 8A-8C illustrate example screens of display at a point-of-sale device or a personal shopping device in accordance with a preferred embodiment of the present invention. More particularly, with reference to FIG. 8A, display 800 includes an itemized list of products selected for purchase. The list includes a product identifier, a product description, and a total for the purchase. Display 800 also includes notification display area 802, which presents a mismatch notification. In this example, the mismatch notification identifies the mismatched items and suggests an alternative item. The mismatch notification also prompts a user to select whether to present directions to the matching item. Buttons 804 are selectable by a user to indicate whether or not to present directions.

FIG. 8B illustrates an example screen of display that presents directions information. Screen 810 includes directions display area 812. Screen 810 may be displayed responsive to the user selecting “YES” button in FIG. 8A. In an alternative embodiment, directions information may include a map display. FIG. 8C illustrates an example screen of display that presents location information. Screen 820 includes a map of the retail environment with an arrow pointing to a location of the suggested matching item.

FIGS. 8A-8C are meant to be illustrative and not to imply limitations to the scope of the present invention. For example, mismatch notification may be presented as audio, using speakers for instance. Location information may also include other information not illustrated in the above described figures. For example, location information may include a picture of the item. A navigation system may also be used to guide the customer based upon the location information.

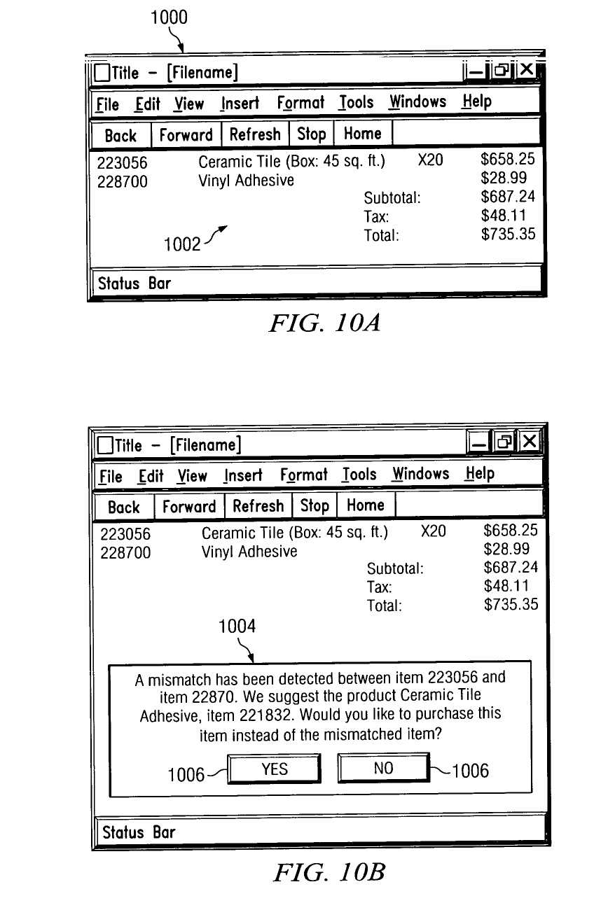

In an alternative embodiment, location information may be printed for the convenience of the customer. For example, location information, which may include directions information, may be printed on receipt tape using a receipt printer at the point-of-sale terminal. FIG. 9 illustrates an example printed presentation of location information in accordance with a preferred embodiment of the present invention. Receipt tape 900 presents directions to a suggested matching item. The customer may receive this receipt paper and follow the directions to the matching item.

Furthermore, receipt paper 900 may also include barcode 902, which identifies a customer transaction. When a mismatched item is identified and the customer wishes to replace the mismatched item with a corresponding matching item, the sales representative may suspend the transaction. Barcode 902 may identify the suspended transaction. When the customer locates the item and returns to the point-of-sale terminal, the sales representative may scan barcode 902 to restore the transaction.

With reference now to FIGS. 10A and 10B, example screens of display illustrating mismatch notification in an online retail environment are shown in accordance with a preferred embodiment of the present invention. More particularly, with reference to FIG. 10A, display 1000 illustrates an example Web browser window including Web page display area 1002. The Web page display area presents an itemized list of products selected for purchase. The list includes a product identifier, a product description, and a total for the purchase.

Turning now to FIG. 10B, the also includes notification display area 1004, which presents a mismatch notification. In this example, the mismatch notification identifies the mismatched items and suggests an alternative item. The mismatch notification also prompts a user to select whether to present directions to the matching item. Buttons 1006 are selectable by a user to indicate whether or not to present directions.

The mismatch may be identified at a Web server, such as server 152 in FIG. 1. The Web server may provide, within hypertext markup language (HTML) Web pages, product information from product data structures to Web clients and notify a user of a Web browser of mismatched items based on mismatch data structures. These Web pages may also include suggestions for matching items based upon match data structures.

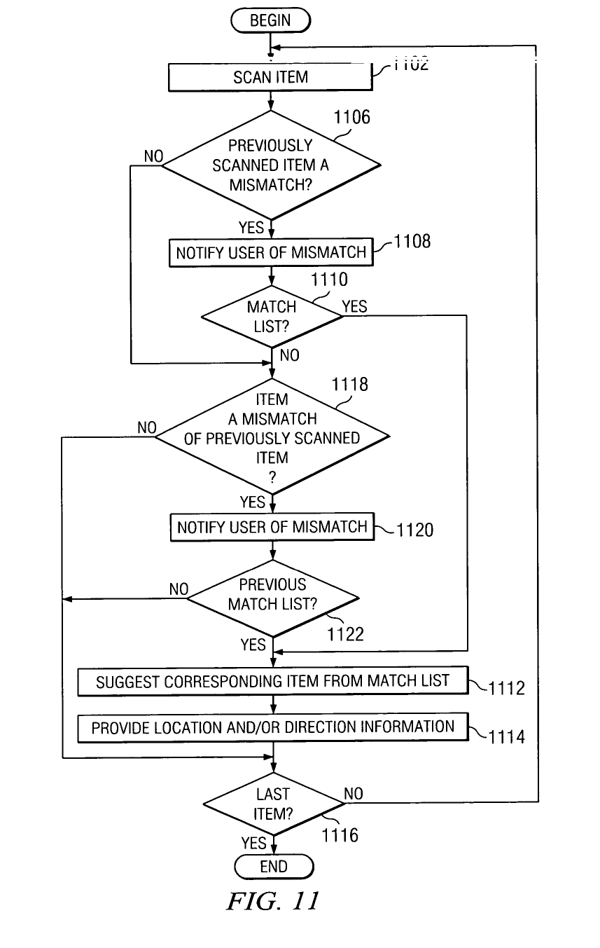

With reference to FIG. 11, a flowchart is shown illustrating the operation of an item mismatch detection process in accordance with a preferred embodiment of the present invention. The process begins and a customer or sales representative scans an item that is selected for purchase (step 1102). An item may be scanned by reading a product barcode, by entering a SKU or UPC identification, or by other data entry mechanisms.

A determination is made as to whether a previously scanned item is a mismatch of the current item (step 1106). This determination may be made by determining whether any previously scanned items are within a “sphere of influence” of the currently scanned item. If any previously scanned items are within a sphere of influence, the items may be compared to a match list or their descriptions may be compared to determine whether the items are mismatched. If a previously scanned item contradicts the description of a matching item or the description of the current item, then the item is a mismatch. An item may also have a mismatch list or data structure, which explicitly identifies mismatching items.

If a previously scanned item is a mismatch, the process notifies a user of the mismatch (step 1108) and a determination is made as to whether the item has a match list (step 1110). A match list may be a list of items that appear in a match data structure. If no matching items are known for a particular item, the item may not have a match data structure referenced in the product data structure. Alternatively, an item with no known matching items may have a referenced match data structure that is empty.

If the item has a match list in step 1110, the process suggests a corresponding item from the match list, if possible, (step 1112) and provides location and/or direction information (step 1114), if possible. Thereafter, a determination is made as to whether the item is the last item (step 1116). This determination may be made, for example, by determining whether a predetermined button or key, such as a “complete sale” key, is depressed. If the item is the last item, the process ends; otherwise, the process returns to step 1102 to scan the next item.

If no previously scanned items are mismatched with the current item in step 1106, a determination is made as to whether the current item is a mismatch of a previously scanned item (step 1118). If the item is a mismatch of a previously scanned item, then the process notifies a user of the mismatch (step 1120) and a determination is made as to whether the previously scanned item has a match list (step 1122).

If the previously scanned item does have a match list, the process suggests a corresponding item from the match list, if possible, (step 1112) and provides location and/or direction information (step 1114), if possible. Thereafter, the process continues to step 1116 to determine whether the item is the last item to be scanned. If, however, the item is not a mismatch of a previously scanned item in step 1118 or the previously scanned item does not have a match list in step 1122, the process continues directly to step 1116 to determine whether the item is the last item to be scanned.

Thus, the present invention solves the disadvantages of the prior art by providing a mechanism for detecting mismatched items purchased together. A data structure includes product information including mismatch information for each product. Mismatch information may be stored in a data structure, such as a mismatch list or table. When products are selected for purchase, the products are compared to determine whether any one product is identified as a mismatch for any other selected item. If a mismatch is detected, a notification is generated.

The data structure may also include match information for each product. Match information may be stored in a match data structure, such as a match list or table. If a mismatch is detected, a corresponding item in the match list may be suggested to the purchaser. Location or direction information may also be presented to the purchaser to locate the matching item.

The retail data processing system of the present invention may also include electronic price tags that transmit for short distances. These electronic price tags may include radio frequency transceivers that can be queried in a pre-checkout scan, allowing the shopper to be alerted of product mismatches or incompatibilities prior to reaching the front of the checkout line. Therefore, customers may avoid waiting in a checkout line multiple times due to mismatching products being inadvertently selected.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, in a data processing system, for detecting item mismatch, the method comprising:
identifying a first item and a second item to be purchased, wherein the first item and the second item have associated product information;
determining whether the first item is a mismatch of the second item based on the product information; and
responsive to the first item being a mismatch of the second item, presenting an item mismatch notification.

2. The method of claim 1, further comprising:
determining whether a matching item corresponding to the first item appears in a match list of the second item; and
responsive to a matching item corresponding to the first item appearing in the match list of the second item, presenting a message suggesting the matching item.

3. The method of claim 2, wherein the message includes location information for the matching item.

4. The method of claim 3, wherein the location information includes one of a map, directions, an aisle number, a shelf number, and coordinates for the matching item.

5. The method of claim 1, further comprising:
determining whether the second item is a mismatch of the first item based on the product information; and
responsive to the second item appearing being a mismatch of the first item, presenting an item mismatch notification.

6. The method of claim 1, wherein the step of identifying a first item and a second item includes scanning a bar code for the first item and scanning a bar code for the second item.

7. The method of claim 1, wherein the step of identifying a first item and a second item includes receiving the product information from electronic tags on the first item and the second item.

8. The method of claim 7, wherein the product information includes a mismatch data structure of the second item.

9. The method of claim 1, wherein the product information includes at least one of a product identifier, a product description, a product type, a mismatch list, and a match list.

10. The method of claim 1, wherein the data processing system is one of a point-of-sale terminal, a Web server, and a personal shopping device.

11. The method of claim 1, wherein the step of determining whether the first item is a mismatch of the second item includes invoking a set of mismatch rules.

12. The method of claim 1, wherein the step of determining whether the first item is a mismatch of the second item includes:
determining whether the first item is within a sphere of influence of the second item; and
responsive to the first item being within a sphere of influence of the second item, comparing product information of the first item with product information of the second item.

13. An apparatus for detecting item mismatch, the apparatus comprising:
identification means for identifying a first item and a second item to be purchased, wherein the first item and the second item have associated product information;
determination means for determining whether the first item is a mismatch of the second item based on the product information; and
presentation means, responsive to the first item being a mismatch of the second item, for presenting an item mismatch notification.

14. The apparatus of claim 13, further comprising:
means for determining whether a matching item corresponding to the first item appears in a match list of the second item; and
means for responsive to a matching item corresponding to the first item appearing in the match list of the second item, presenting a message suggesting the matching item.

15. The apparatus of claim 14, wherein the message includes location information for the matching item.

16. The apparatus of claim 15, wherein the location information includes one of a map, directions, an aisle number, a shelf number, and coordinates for the matching item.

17. The apparatus of claim 13, wherein the identification means includes means for scanning a bar code for the first item and scanning a bar code for the second item.

18. The apparatus of claim 13, wherein the identification means includes means for receiving the product information from electronic tags on the first item and the second item.

19. The apparatus of claim 18, wherein the product information includes a mismatch data structure of the second item.

20. The apparatus of claim 13, wherein the product information includes at least one of a product identifier, a product description, a product type, a mismatch list, and a match list.

21. The apparatus of claim 13, wherein the apparatus is one of a point-of-sale terminal, a Web server, and a personal shopping device.

22. A computer program product, in a computer readable medium, for detecting item mismatch, the computer program product comprising:
instructions for identifying a first item and a second item to be purchased, wherein the first item and the second item have associated product information;
instructions for determining whether the first item is a mismatch of the second item based on the product information; and
instructions, responsive to the first item being a mismatch of the second item, for presenting an item mismatch notification.
